(19) United States
(12) Patent Application Publication
(10) Pub. No.: US 2008/0008134 A1
(43) Pub. Date: Jan. 10, 2008

(54) Communications system transmitting/receiving using plural antennas, transmission apparatus and reception apparatus of the system

(75) Inventors: Hideyori Satou, Kawasaki (JP); Shinji Konta, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/819,040

(22) Filed: Jun. 25, 2007

(30) Foreign Application Priority Data
Jul. 5, 2006 (JP) 2006-185235

(51) Int. Cl. H04Q 7/06

(52) U.S. Cl. 370/334

(57) ABSTRACT

In a disclosed transmission apparatus, a control channel transmission antenna number selection control portion selects the number of transmission antennas that transmit a control channel in accordance with transmission quality information received from a quality information measurement portion of a reception apparatus. In addition, a control channel generation portion generates multiplexed transmission control information obtained by multiplexing multiple pieces of transmission control information for corresponding radio signals and storing the generated multiplexed transmission control information in a control channel area of at least one of transmission frames for transmitting the information. The number of the transmission antennas that transmit the control channel is determined to be one, the maximum number of the transmission antennas, or any number between one and the maximum number.

### BACKGROUND OF THE INVENTION

1. Field of the Invention

The present invention relates to a communications system that transmits/receives through one or more antennas in accordance with a MIMO (Multiple-Input Multiple-Output) method or the like, a transmission apparatus, and a reception apparatus for the communications system. Specifically, the present invention relates to a communications system, a transmission apparatus, and a reception apparatus that are capable of effectively transmitting a control channel.

2. Description of the Related Art

Currently, the MIMO method is drawing much attention as a technology that enables high capacity (high speed) data communications by effectively utilizing a frequency band. The MIMO method uses a reception apparatus having plural antennas and a transmission apparatus having plural antennas. The MIMO method transmits independent data streams from the plural antennas of the transmission apparatus and the data streams are received by each antenna of the reception apparatus. The reception apparatus can separate into individual data streams the received signal that has the data streams mixed over propagation channels, thereby improving the transmission rate without expanding the frequency band. In addition to the MIMO method, a MISO (Multiple-Input Single-Output) method, where only a transmission apparatus has plural antennas, and a SIMO (Single-Input Multiple-Output) method, where only a reception apparatus has plural antennas, have been proposed.

Since a mobile communications system is now required to deal with multimedia communications and Internet access, the system needs to efficiently transmit radio signals at various transmission rates and qualities. A control channel, which transmits transmission control information for a radio signal, is divided into plural blocks for controlling transmission through corresponding antennas, and each block stores control information for the corresponding antenna.

There is described a transmission method based on a time division multiple access control channel in a conventional MIMO method mobile communications system that uses four transmission antennas and four reception antennas (4×4 antenna). By the way, the present invention can be practiced employing other multiple transmission methods such as a code division multiple access method using a spreading code in addition to the time multiple method.

In order to transmit fourfold control channels, there are a 1Tx control channel transmission method in which the channels are transmitted from one transmission antenna and a multi-antenna control channel transmission method in which the channels are transmitted from plural antennas.

(1) 1Tx Control Channel Transmission Method

In the 1Tx channel transmission method of the MIMO (Multiple-Input Multiple-Output) mobile communications system, multiple pieces of transmission control information that should be stored in control channels for corresponding antennas are multiplexed; the multiplexed transmission control information is transmitted from one transmission antenna; and the transmission control of the radio signals transmitted/received from each antenna is performed based on the multiplexed transmission control information transmitted from the one transmission antenna. FIG. 1 shows an example of transmission frame formats when the transmission control information is transmitted based on the time divisional multiple access method.

As shown in FIG. 1, control channel blocks for first through fourth transmission antennas (#1-#4) are time divisionally multiplexed and stored only in a control channel area of a transmission frame for a first transmission antenna (#1), whereas no data are stored in control channel areas of transmission frames for the second through the fourth transmission antennas (#2-#4). By the way, transmission data stored in the data channels of the transmission frames for corresponding antennas may be different from one another.

(2) Multiple Antenna Control Channel Transmission

In the multiple antenna control transmission method of the MIMO (Multiple Input Multiple Output) mobile communications system, multiple pieces of transmission control information that should be stored in control channel areas of transmission frames for corresponding antennas are multiplexed; the multiplexed transmission control information is stored in every control channel area of the transmission frames for all the antennas and transmitted from the plural antennas; and the transmission control of the radio signals transmitted/received from each antenna is performed based on the multiplexed transmission control information transmitted from each transmission antenna. FIG. 2 shows an example of transmission frame formats when the transmission control information is transmitted based on time divisional multiple access method.

As shown in FIG. 2, control channel blocks for the first through the fourth transmission antennas (#1-#4) are time divisionally multiplexed; the multiplexed control channels are stored in the control channel areas of the transmission frames for the first through the fourth transmission antennas (#1-#4); and the transmission frames for the first through the fourth transmission antennas (#1-#4) are simultaneously transmitted from the first through the fourth antennas (#1-#4). By the way, transmission data stored in the data channels of the transmission frames for corresponding antennas may be different from one another.

Patent-related document 1 discloses a transmission apparatus employing the Space Division Multiplexing method. The transmission apparatus has two or more antennas and space divisionally multiplexes data having one or more sequences using a same frequency channel so as to transmit the data. The transmission apparatus has a transmission portion that generates space division multiplexing control data including the number of the antennas for use in transmitting among the two or more antennas and the number of data sequences to be transmitted. The transmission portion includes the space division multiplexing control data in at least one data sequence, thereby transmitting the control data.
<Patent-related Document 1>Japanese Patent Application Laid-Open Publication No. 2004-297172.

In the aforementioned 1Tx control channel transmission method, since the transmission control information of the control channels for corresponding antennas is transmitted through one control channel area for one transmission antenna, the transmission control information may be received less efficiently than the transmission data in the data channels, depending on interference from other antennas and degradation in communications channels.

In this case, the transmission data cannot be demodulated even when the transmission data in the data channel are accurately received, if the transmission control information is not accurately received. Obviously, increased transmission power may be an effective way to improve reception of the control channel information. However, this is not always a practical solution, because the transmission power for each antenna cannot be increased beyond power source capacity.

On the other hand, in the aforementioned multi-antenna control channel method, since the transmission control information including all the control channels for corresponding antennas is stored in all the control channel areas and the control channels are transmitted, reception of the transmission control information is ensured by superposing the control channel areas of each transmission frame received by each antenna, compared with the 1Tx control channel transmission method, even when the propagation channels are in a degraded condition. However, when the propagation channels are in a good condition, the transmission power is unduly consumed by transmitting the transmission control information through all the antennas.

In other words, in the conventional multi-antenna control channel transmission method, since the transmission control information is stored in every control channel area and transmitted through a fixed number of transmission antennas regardless of the propagation channel conditions, such transmission consumes unnecessary electric power and also interferes with other communications.

Moreover, in the 1Tx antenna transmission method, the control channel is influenced by noise more heavily than the data channel, depending on the modulation method for transmitting data. If this happens, the control channel cannot be received even when the data channel is successfully received, which results in unsuccessful demodulation of the transmission data in the data channel.

The objective of the present invention is to improve reception of the control channel while eliminating unnecessary consumption of transmission power for transmitting the control channel.

### SUMMARY OF THE INVENTION

A first aspect of the present invention provides a communications system that comprises a transmission apparatus that transmits radio signals using a plurality of transmission antennas; and a reception apparatus that receives the radio signals using a plurality of reception antennas. In the communications system, multiplexed transmission control information is stored to be transmitted in a control channel area of at least one of transmission frames for corresponding radio signals transmitted from the plural transmission antennas, the multiplexed transmission control information being obtained by multiplexing pieces of transmission control information for radio signals transmitted from the plural transmission antennas. In addition, the reception apparatus includes a transmission quality information notification portion that measures transmission quality of the radio signals from the transmission apparatus so as to obtain transmission quality information and transmits the transmission quality information to the transmission apparatus, and the transmission apparatus includes a transmission antenna number selection portion that selects the number of antennas that transmit the multiplexed transmission control information in accordance with the transmission quality information received from the reception apparatus.

A second aspect of the present invention provides the communications system according to the first aspect, where the transmission apparatus and the reception apparatus further include an antenna number selection table that stores antenna numbers corresponding to the transmission quality information, where the transmission apparatus refers to the antenna number selection table so as to determine the number of the transmission antennas for use in transmitting the multiplexed transmission control information, and where the reception apparatus refers to the antenna number selection table so as to determine the number of the reception antennas for use in receiving the multiplexed transmission control information.

A third aspect of the present invention provides the communications system according to the first or the second aspect, where when the reception apparatus determines that the number of reception errors is more than or equal to a predetermined number, the reception apparatus notifies the transmission apparatus of propagation channel anomaly as the transmission quality information and selects the maximum number of the reception antennas for use in receiving the multiplexed transmission control information, and when the transmission apparatus is notified of the propagation channel anomaly the transmission apparatus selects the maximum number of the transmission antennas for use in transmitting the multiplexed transmission control information.

A fourth aspect of the present invention provides a transmission apparatus that comprises a plurality of transmission antennas; a transmission antenna number selection portion that selects the number of transmission antennas that transmit multiplexed transmission control information obtained by multiplexing multiple pieces of transmission control information for corresponding radio signals in accordance with transmission quality information transmitted from a reception apparatus; and a notification portion that notifies the reception apparatus of the selected number of the transmission antennas.

A fifth aspect of the present invention provides a reception apparatus that comprises a plurality of reception antennas; a transmission quality notification portion that notifies a transmission apparatus of transmission quality information determined in accordance with a reception signal; an antenna number selection table that stores the number of the reception antennas in accordance with the transmission quality information; and a reception antenna number selection portion that selects in reference to the antenna number selection table the number of the reception antennas for use in receiving multiplexed transmission control information obtained by multiplexing multiple pieces of transmission control information for corresponding radio signals.

According to these aspects of the present invention, the number of antennas that transmit the multiplexed transmission control information in the control channel area can be determined in accordance with the propagation channel condition. Therefore, when the propagation channel is in good condition, unnecessary electric power consumption, which is caused if the multiplexed transmission control information is transmitted through plural antennas, is prevented. In addition, when the propagation channel is in poor condition, the number of antennas that transmit the control channel in which the multiplexed transmission control information is stored is increased, so that a reception rate of the transmission control information through superposed reception is improved, thereby retaining propagation quality comparable to the propagation quality realized by the multi-antenna control channel method.

### BRIEF DESCRIPTION OF THE DRAWINGS

In accompanying drawings:

FIG. 1 is an example of a transmission frame format according to the 1Tx control channel transmission method;

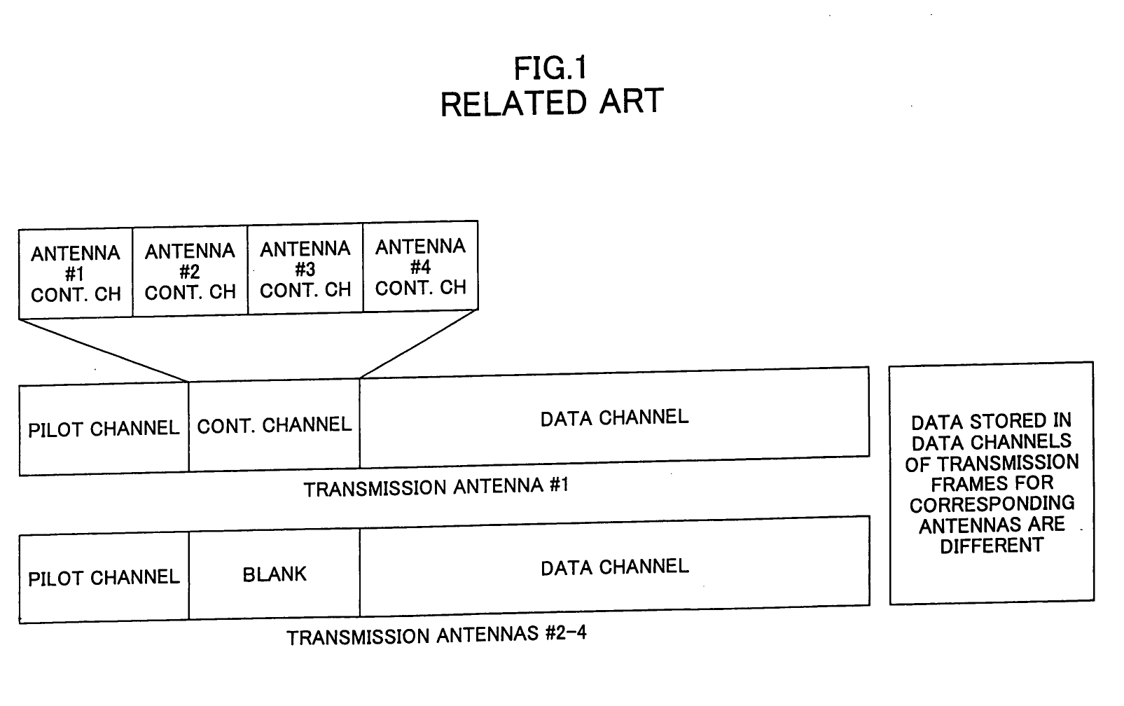

FIG. 2 is an example of a transmission frame format according to the multi-antenna control channel transmission method;

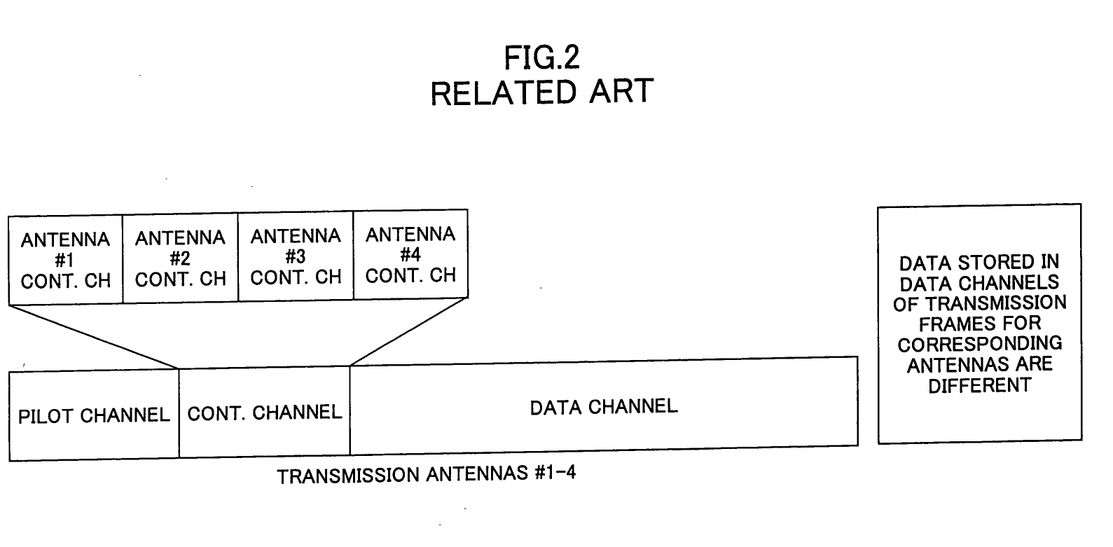

FIG. 3 is a functional block diagram of a transmission apparatus and a reception apparatus according to an embodiment of the present invention;

FIG. 4 is an example of a flowchart of the transmission apparatus according to the embodiment of the present invention; and

FIG. 5 is an example of a flowchart of the reception apparatus according to the embodiment of the present invention.

### DETAILED DESCRIPTION OF THE PREFERRED EMBODIMENT

Referring to the accompanying drawings, embodiments of the present invention will be described.

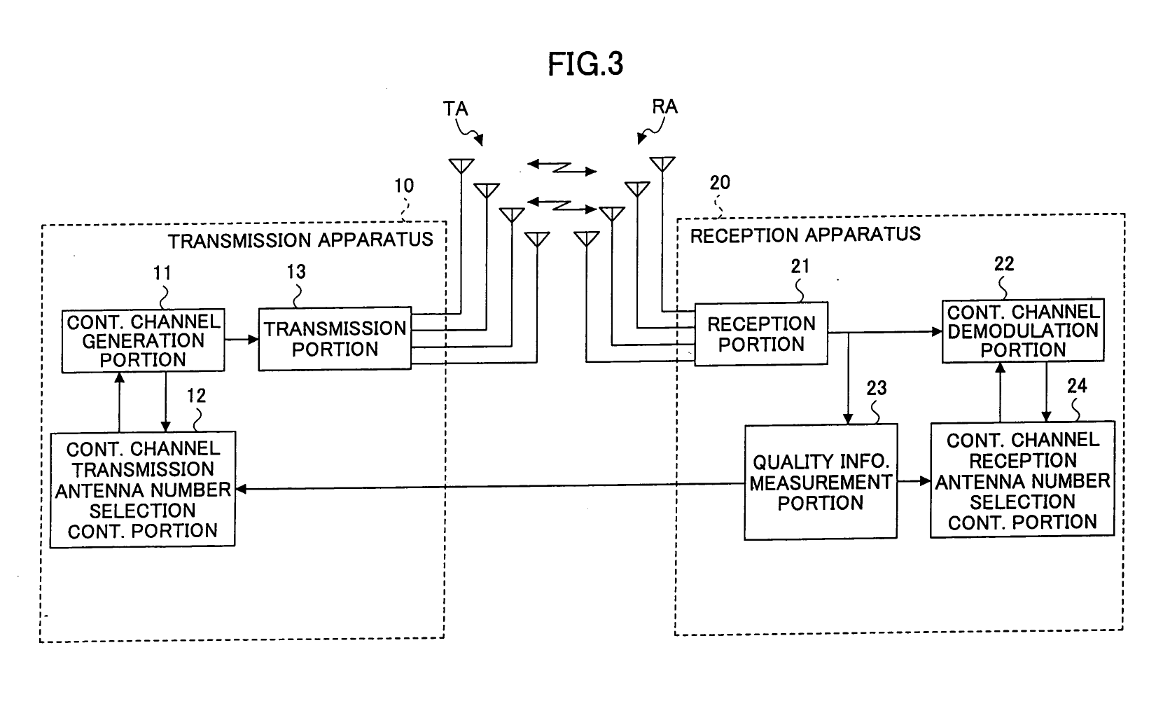

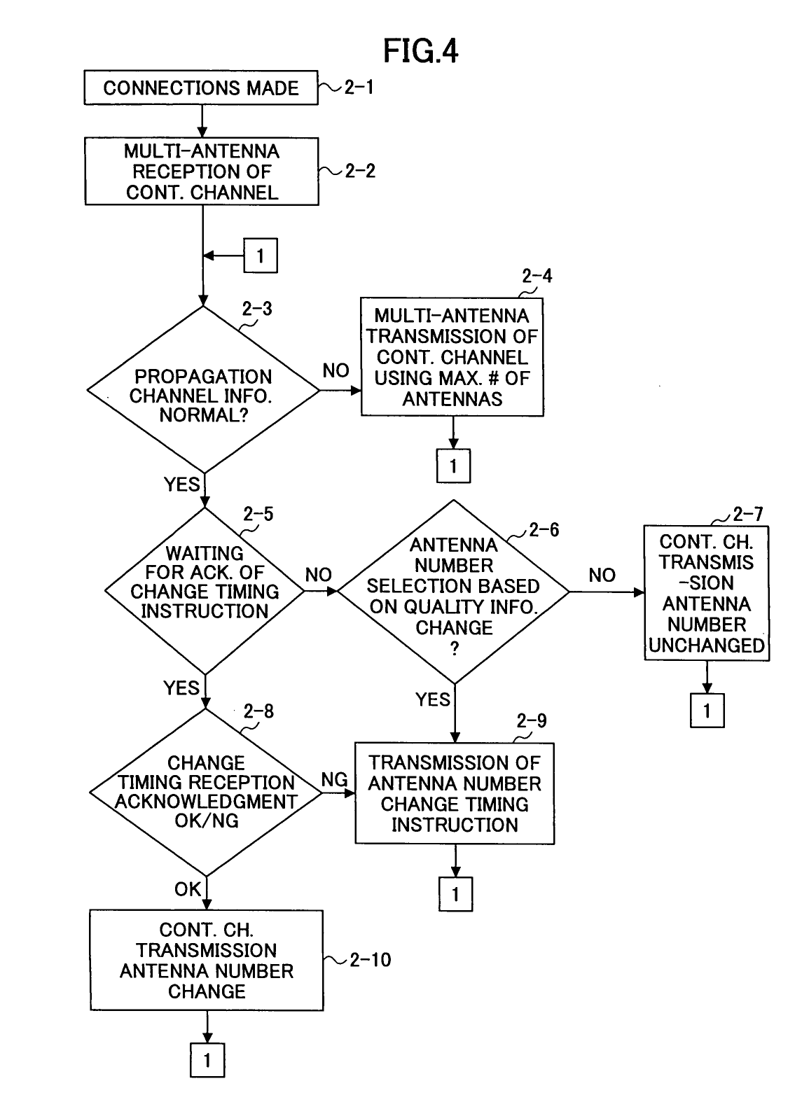

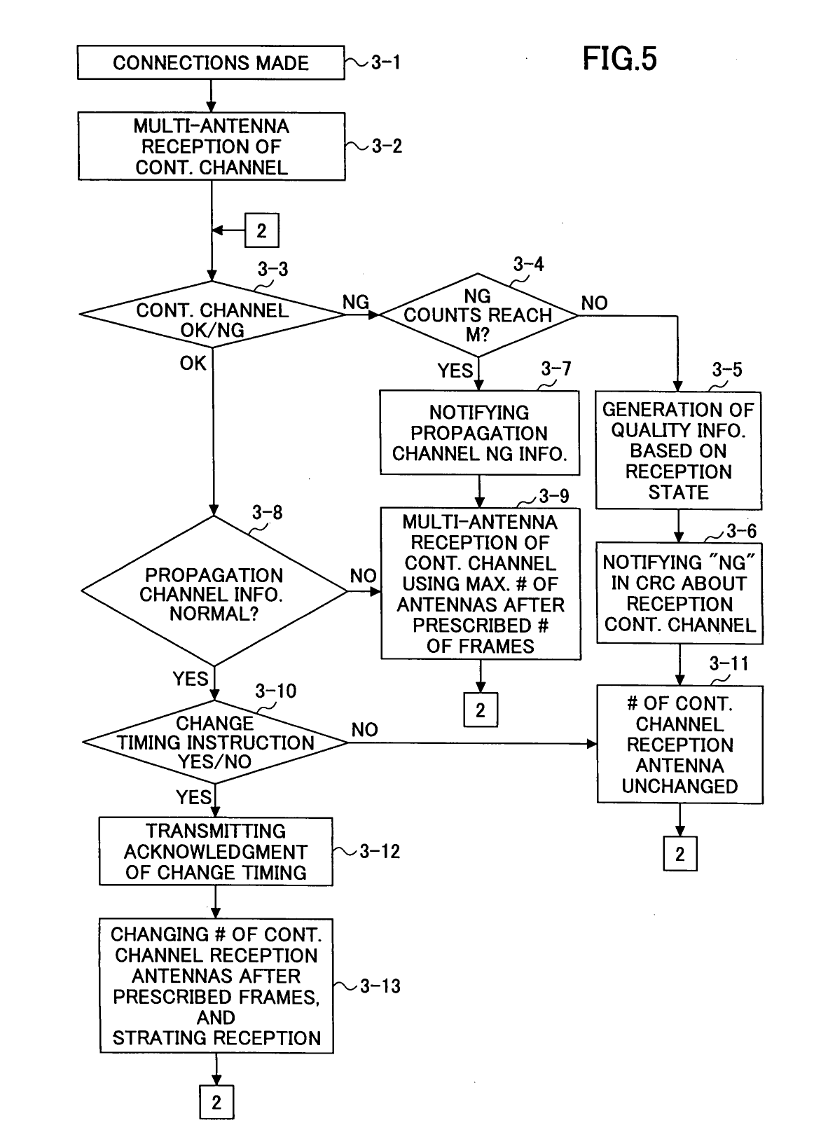

FIG. 3 illustrates function blocks of a transmission apparatus and a reception apparatus of a communications system according to an embodiment of the present invention. In addition, FIG. 4 is a flowchart illustrating an operational sequence of the transmission apparatus according to the embodiment of the present invention. FIG. 5 illustrates another flowchart illustrating an operational sequence of the reception apparatus according to the embodiment of the present invention.

In a transmission apparatus 10, an antenna number selection control portion 12 configured to select the number of control channel transmission antennas recognizes a current condition of a propagation channel based on transmission quality information transmitted from a quality information measurement portion 23 of a reception apparatus 20 so as to select the number of the transmission antennas for use in transmitting a control channel depending on the condition of the propagation channel. In addition, the antenna number selection control portion 12 informs a control channel generation portion 11 of the number of the selected transmission antennas.

The control channel generation portion 11 generates the control channel that includes multiplexed transmission control information obtained by multiplexing multiple pieces of transmission control information of radio signals for corresponding transmission antennas in control channel areas of radio signal transmission frames. Here, the number of the radio signal transmission frames corresponds to the number of the transmission antennas selected by the antenna number selection control portion 12. Then, a transmission portion 13 organizes transmission frames that include the control channel generated by the control channel generation portion 11 and a data channel for corresponding transmission antennas, and transmits the transmission frames through plural transmission antennas TA.

In the reception apparatus 20, a reception signal from the transmission portion 13 of the transmission apparatus 10 is received by a reception portion 21 through plural reception antennas RA. Then, a control channel demodulation portion 22 demodulates the control channel from the reception signal under control of a control channel reception antenna selection control portion 24 so as to obtain the information on the number of control channel transmission antennas. The control channel demodulation portion 22 sends the information to the control channel reception antenna selection control portion 24 which in turn determines based on the information on the number of the control channel transmission antennas whether the number of control channel transmission antennas has been changed.

By the way, when connections between the transmission apparatus 10 and the reception apparatus 20 are first made, the number of the control channel transmission antennas cannot be selected based on the transmission quality information. Therefore, the control channels are first transmitted by the multi-antenna control channel transmission method and then the transmission environment is observed based on the transmission quality information obtained by the quality information measurement portion 23 of the reception apparatus 20. Then, either the 1Tx control channel transmission method or the multi-antenna control channel transmission method is selected to transmit the control channel.

When the transmission methods are switched from 1Tx control channel transmission method to the multi-antenna control channel transmission method, or otherwise, control channel transmission selection bits stored as the transmission control information in the control channels are changed and notification of the change is sent to the reception apparatus 20. When the reception apparatus 20 recognizes the change in the number of the control channel transmission antennas, the reception apparatus 20 transmits an acknowledgment (ACK) of the proper reception of the change notification. After confirming that the change in the number of the control channel transmission antennas has been acknowledged, the transmission apparatus 10 changes the number of the control channel transmission antennas.

Although the change in the number of the control channel transmission antennas typically means a change from one antenna to the maximum number of antennas, the number may be changed from one to N (1<N< the maximum number) depending on the transmission environment, which is an embodiment according to the present invention. Obviously, in this case, the control channel transmission selection bits stored as the transmission control information in the control channels are required to be capable of representing any number from 1 to the maximum number.

In addition, when the number of the control channel transmission antennas is changed, the transmission apparatus 10 and the reception apparatus 20 may include identical antenna number selection tables for selecting the number of the control channel transmission antennas based on the transmission quality information, which makes it possible to quickly change the number of the control channel transmission antennas based on the transmission quality information in both the transmission apparatus 10 and the reception apparatus 20.

In this case, it is not necessary to store the control channel transmission selection bits in the control channel in order to inform the reception apparatus 20 of the bits. However, it is required to determine that the transmission quality information is properly transmitted from the reception apparatus 20 to the transmission apparatus 10. Namely, after the reception apparatus 20 receives from the transmission apparatus 10 the acknowledgment (ACK) indicating the successful reception of the transmission quality information from the reception apparatus 20, the number of the control channel transmission antennas is changed.

In addition, when an optimum number of the control channel transmission antennas is selected, an abrupt change in a propagation channel condition may prevent the control channel from being properly received. In order to address such a disadvantage, the reception apparatus 20 may be configured to count the number of reception errors of the reception signal (transmission control information) including the control channel. When the reception apparatus 20 detects that the number of reception errors reaches a predetermined number, the reception apparatus 20 places transmission channel abnormal bits in the storing area of the transmission quality information and informs the transmission apparatus 10 of the anomaly in the propagation channel, which allows the reception apparatus 20 and the transmission apparatus 10 to select the maximum number of the antennas so as to transmit/receive the control channel.

Also in the embodiment any number, between one and the maximum number, of the control channel transmission antennas can be selected since the number of the control channel transmission antennas cannot be selected based on the transmission quality information measured by the reception apparatus 20 when the connections between the transmission apparatus 10 and the reception apparatus 10 are first made. In this case, the control channel can be first transmitted using a predetermined number K of the antennas.

Referring to FIG. 4, an example of an operational sequence of the transmission apparatus according to an embodiment of the present invention is explained. When the connections between the transmission apparatus 10 and the reception apparatus 20 are first made (2-1), the transmission apparatus 10 transmits the control channel employing the multi-antenna control channel transmission method (2-2). Then, the transmission apparatus 10 determines whether the propagation channel condition is normal based on the transmission quality information transmitted from the reception apparatus 20 (2-3). When the transmission apparatus determines that the propagation channel condition is not normal (NO at step 2-3), the transmission apparatus transmits the control channel using the maximum number of the antennas (2-4). Then, the sequence is returned to step 2-3.

When the reception apparatus 20 determines that the propagation channel condition is normal (YES at step 2-3), it is further determined whether an acknowledgment of an instruction of timing to change the number of the control channel transmission antennas is awaited (2-5). When the acknowledgment is determined to not be awaited, it is then determined based on the transmission quality information whether the number of the control channel transmission antennas should be changed (2-6). When it is determined that the number of the control channel transmission antennas is not to be changed (NO at step 2-6), the number is maintained the same (2-7). Then, the sequence is returned to step 2-3.

When the number of the control channel transmission antennas is determined to be changed (YES at step 2-6), the instruction of the timing to change the number of the control channel transmission antennas determined based on the transmission quality information is transmitted to the reception apparatus 20 (2-9). Then, the sequence is returned to step 2-3.

In addition, when it is determined at step 2-5 that the acknowledgment of the instruction of the timing to change the number of the control channel transmission antennas is awaited, it is then determined whether the acknowledgment of the instruction is properly received from the transmission apparatus 10 (2-8). When the acknowledgment is determined to not be properly received, step 2-9 is carried out as explained above. Then, the sequence is returned to step 2-3. On the other hand, when it is determined at step 2-8 that the acknowledgment is properly received, the number of the control channel transmission antennas is changed in accordance with the transmission quality information (2-10). Then, the sequence is returned to step 2-3.

Referring to FIG. 5, an example of an operational sequence of the reception apparatus according to an embodiment of the present invention is explained. When the connections between the transmission apparatus 10 and the reception apparatus 20 are first made (3-1), the reception apparatus 20 receives the control channel employing the multi-antenna control channel transmission method (3-2). Then, the reception apparatus 20 determines whether the reception information of the control channel transmitted from the transmission apparatus is properly received without errors (3-3).

When the reception information of the control channel is not properly received (NG at step 3-3), it is further determined whether the number of the abnormal receptions reaches a predetermined value M (3-4). When the number of the improper receptions does not reach the predetermined value M (NO at step 3-4), the transmission quality information is generated (3-5); the reception apparatus 10 is informed that the Cyclic Redundancy Check (CRC) performed for the control channel of the reception signal results in failure (3-6); and the number of the control channel reception antennas is unchanged (3-11). Then, the sequence is returned to step 3-3.

When it is determined at step 3-4 that the number of the improper receptions reaches the predetermined value M, the reception apparatus 20 is informed of the transmission quality information which indicates that the propagation channel is in an abnormal condition (3-7). Then, after a prescribed number of frames are sent, the multi-antenna control channel transmission method using the maximum number of the control transmission antennas is employed, so that the control channel is received (3-9). Then, the sequence is returned to step 3-3.

When it is determined at step 3-3 that the reception information of the control channel is properly received (OK at step 3-3), it is further determined based on the received information whether the propagation channel is in an abnormal condition (3-8). When the transmission channel is determined to be in an abnormal condition, the multi-antenna control channel method is adopted so as to receive the control channel through the maximum number of the antennas (3-9). Then; the sequence is returned to step 3-3.

When it is determined at step 3-8 that the transmission channel is in a normal condition, it is further determined whether the instruction of the timing to change the number of the control channel transmission antennas is received from the transmission apparatus 10 (3-10). When such an instruction is not received, the number of the control channel reception antennas is kept the same (3-11). Then, the sequence is returned to step 3-3.

When it is determined at step 3-10 that the instruction of the timing to change the number of the control channel transmission antennas is received, an acknowledgment of the reception of the instruction is transmitted to the transmission apparatus 10 (3-12). After a period of time corresponding to the frames determined by the instruction for the change timing elapses, the control channel is received through the predetermined number of the reception antennas (3-13). Then, the sequence is returned to step 3-3.

A first additional embodiment of the present invention provides a communications system which includes a transmission apparatus that transmits a radio signal using plural transmission antennas and a reception apparatus that receives the radio signal using plural reception antennas. In the communications system, the multiple pieces of transmission control information of each radio signal transmitted from the corresponding antennas are multiplexed and the multiplexed transmission control information is stored in at least one of the control channel areas of the radio signal transmission frame for the transmission antennas. The communications system includes in the reception apparatus a transmission quality notification portion that obtains transmission quality information of the radio signal from the transmission apparatus and notifies the transmission apparatus of the transmission quality information. Moreover, the communications system includes in the transmission apparatus a transmission antenna number selection portion that selects the number of the transmission antennas for use in transmitting the multiplexed transmission control information based on the transmission quality information received from the transmission apparatus.

A second additional embodiment of the present invention provides the communications system according to the another embodiment, where both the transmission apparatus and the reception apparatus have antenna selection tables that store the number of antennas associated with the transmission quality information, where the both apparatuses refer to the antennas selection tables on the basis of the transmission quality information to recognize the number of the transmission antennas for use in transmitting the multiplexed transmission control information so as to select the number of the reception antennas and the transmission antennas for use in the multiplexed transmission control information.

A third additional embodiment of the present invention, the reception apparatus in the first or the second additional embodiments gives notice of an abnormal condition of the transmission paths as the transmission quality information to the reception apparatus in case the number of times when the multiplexed transmission control information is erroneously detected exceeds a predetermined number of times and the reception apparatus selects the maximum number of the transmission antennas for use in transmitting the multiplexed transmission control information when the reception apparatus receives the notice of the abnormal condition of the transmission paths from the transmission apparatus.

Additionally, a fourth additional embodiment of the present invention provides a transmission apparatus that stores in the control channel area of the transmission frame for at least one transmission antenna for a radio signal multiplexed transmission control information obtained by multiplexing the transmission control information of a radio signal to be transmitted through each transmission antenna and transmits the information. The transmission apparatus includes an antenna number selection portion that selects the number of transmission antennas based on the transmission quality information transmitted from a reception apparatus and a notification portion that notifies the reception apparatus of the number of selected transmission antennas.

A fifth additional embodiment according to the present invention provides a reception apparatus that receives a radio signal that stores in at least one control channel area of transmission frames for radio signals multiplexed transmission control information obtained by multiplexing all the transmission control information of radio signals received using multiple antennas. The reception apparatus includes a transmission quality notification portion that notifies a transmission apparatus of transmission quality information measured based on a reception signal, an antenna number selection table that stores the number of reception antennas in accordance with the transmission quality information, and a reception antenna number selection portion that refers to the antenna number selection table so as to select the number of reception antennas for use in receiving the multiplexed transmission control information stored in the control channel area of the radio signal.

The transmission antenna number selection portion of the first additional embodiment of the communications system may select one antenna or the maximum number of antennas.

The transmission antenna number selection portion of the first additional embodiment of the communications system may select any one of one though the maximum number of transmission antennas.

The transmission antenna number selection portion of the fourth additional embodiment of the transmission apparatus may select one antenna or the maximum number of antennas.

The transmission antenna number selection portion of the fourth additional embodiment of the transmission apparatus may select any one of one though the maximum number of transmission antennas.

The present application is based on Japanese Priority Application No. 2006-185235 filed on Jul. 5, 2006, with the Japanese Patent Office, the entire contents of which are hereby incorporated by reference.

What is claimed is:

1. A communications system comprising:
a transmission apparatus that transmits radio signals using a plurality of transmission antennas; and
a reception apparatus that receives the radio signals using a plurality of reception antennas;
wherein multiplexed transmission control information is stored to be transmitted in a control channel area of at least one of transmission frames for the corresponding radio signals transmitted from the plural transmission antennas, the multiplexed transmission control information being obtained by multiplexing pieces of transmission control information for radio signals transmitted from the plural the transmission antennas,
wherein the reception apparatus includes a transmission quality information notification portion that measures transmission quality of the radio signals from the transmission apparatus so as to obtain transmission quality information and transmits the transmission quality information to the transmission apparatus, and
wherein the transmission apparatus includes a transmission antenna number selection portion that selects the number of antennas that transmits the multiplexed transmission control information in accordance with the transmission quality information received from the reception apparatus.

2. The communications system of claim 1,
wherein the transmission apparatus and the reception apparatus further include an antenna number selection table that stores antenna numbers corresponding to the transmission quality information,
wherein the transmission apparatus refers to the antenna number selection table so as to determine the number of the transmission antennas for use in transmitting the multiplexed transmission control information, and
wherein the reception apparatus refers to the antenna number selection table so as to determine the number of the reception antennas for use in receiving the multiplexed transmission control information.

3. The communications system of claim 1,
wherein when the reception apparatus determines that the number of reception errors is more than or equal to a predetermined number the reception apparatus notifies the transmission apparatus of a propagation channel anomaly as the transmission quality information and selects the maximum number of the reception antennas for use in receiving the multiplexed transmission control information, and
wherein when the transmission apparatus is notified of the propagation channel anomaly the transmission apparatus selects the maximum number of the transmission antennas for use in transmitting the multiplexed transmission control information.

4. A transmission apparatus comprising:
a plurality of transmission antennas;
a transmission antenna number selection portion that selects the number of the transmission antennas that transmit multiplexed transmission control information obtained by multiplexing multiple pieces of transmission control information for corresponding radio signals in accordance with transmission quality information transmitted from a reception apparatus; and
a notification portion that notifies the reception apparatus of the selected number of the transmission antennas.

5. A reception apparatus comprising:
a plurality of reception antennas;
a transmission quality notification portion that notifies a transmission apparatus of transmission quality information determined in accordance with a reception signal;
an antenna number selection table that stores the number of the reception antennas in accordance with the transmission quality information; and
a reception antenna number selection portion that selects in reference to the antenna number selection table the number of the reception antennas for use in receiving multiplexed transmission control information obtained by multiplexing multiple pieces of transmission control information for corresponding radio signals.
